(19) United States
(12) Patent Application Publication
(10) Pub. No.: US 2022/0194771 A1
(43) Pub. Date: Jun. 23, 2022

(54) Container Handling System, Container Carrier, and Method for Filling Containers

(71) Applicant: KHS GmbH, Dortmund (DE)

(72) Inventor: Alex Seewald-Raider, Bad Kreuznach (DE)

(21) Appl. No.: 17/426,030

(22) PCT Filed: Feb. 17, 2020
(86) PCT No.: PCT/EP2020/054076

§ 371 Date: Jul. 28, 2021

(30) Foreign Application Priority Data
Mar. 4, 2019 (DE) 10 2019 105 342.0

(51) Int. Cl. B67C 3/20; B67C 3/00; B67C 3/24; G01G 17/06

(52) U.S. Cl. CPC B67C 3/202; G01G 17/06; B67C 3/242; B67C 3/007

(57) ABSTRACT

A container carrier connects to a filling machine with a gripper on one end that suspends a container during transport thereof along a transport direction. A deformation sensor arranged on a surface of the carrier detects the carrier's deformation when, as a container is filled, the weight of filling product deforms the carrier.

### RELATED APPLICATIONS

This is the national stage of international application PCT/EP2020/054076, filed on Feb. 17, 2020, which claims the benefit of the Mar. 4, 2019 priority date of German application DE102019105342.0, the contents of which are herein incorporated by reference.

### FIELD OF INVENTION

The invention relates to handling of containers for mass-produced beverages.

### BACKGROUND

In the mass-production of beverages, it is useful for beverage containers of the same type to hold the same amount of product. This is the case whether the product is a liquid, such as a beverage, a dairy product, a sauce, and the like, or a dry product, such as a powder, examples of which include dried soups, coffee powder, baking additives.

Examples of containers include those made of glass, plastic, or metal such as cans, bottles, flasks, tubes, cardboard packages, beakers, film packages, bags, and pouches. Containers are typically sealed, welded, or closed or covered for with a cap, cover, film, or similar closing means.

One way to ensure that a container has the correct amount of product is to weigh the container as it is being filled. However, a weighing cell consumes considerable space.

### SUMMARY

An object of the invention is that of providing a way to measure how much product is in a container as it is being filled in a manner that requires less space than having a weighing cell.

In one aspect, the invention features a container handling system, such as a filling machine, in which containers are transported along a transport direction and are filled with a filler product. The filling of the containers usually takes place during the transport. Containers are understood to be bottles, cans, or similar containers, wherein the precise type and/or form of the containers is not of significance for the present invention. Likewise, the material of the containers is not of importance for the present invention, i.e. they may be, for example, containers made of glass, PET, or aluminum. The transport of the containers is carried out with container carriers, which are or can be adjusted to the respective containers concerned. As used herein, a container carrier should be understood to be any active or passive gripper, clip, or holder, by means of which a suspended transport of one or more containers is possible.

It is therefore possible for containers that have a collar in their upper region to be suspended by a container carrier with a semicircular cut-out opening which is matched to the collar. The filling of the containers takes place by means of filling elements of the filling machine. Such a filling element comprises, for example, an outlet, which for the filling of the free-hanging container is positioned above an opening of the container, and a filling valve, which preferably can be controlled. The container-handling system further comprises a weighing unit or deformation-sensor system for detecting the weight of a container held on the container carrier. The weighing unit comprises a deformation sensor. In some embodiments, the deformation sensor is integral with the carrier. In others, it is on a component of the carrier. Among these are embodiments in which the sensor is a strain gauge and those in which the sensor is on a gripper arm of the carrier.

With the aid of the weighing unit, during the filling of the containers, it is possible to determine the container's weight and therefore how much filling product has been dispensed by the filling element. This makes it possible to reach a predetermined weight of the container and therefore a predetermined filling volume. Upon reaching this desired weight or volume, the filling valve is closed, thus ending the filling of the container.

According to the invention, the weighing unit comprises at least one deformation sensor. The deformation sensor is arranged on a surface portion of the container carrier such that the deformation sensor detects the deformation of the container carrier. This deformation arises from the increase in weight that results from filling the container. This increase causes the cantilevered carrier to bend out of shape. The greater the weight of the container, the more the carrier deforms.

The deformation of the container carrier is therefore a measure of the container's weight. The deformation sensor, as described heretofore, is particularly advantageously arranged directly in or on a surface portion of the container carrier or of a component of the container carrier, i.e. the deformation sensor is preferably in contact directly and with its full surface on the surface portion, such as one or both gripper arms, such that a flat surface working effect connection is produced between the deformation sensor and the surface portion. Moreover, the deformation sensor can also be accommodated and/or integrated in the container carrier, such as being cast into a cut-out opening with an adhesive or resin. It is understood that corresponding connections for a suitable evaluation and control unit are provided, as well as at least one voltage supply.

An advantage that arises as a result of the foregoing is that the additional space requirement in relation to a container carrier without a deformation sensor is substantially reduced. The evaluation of measurement and/or operational data takes place in the weighing unit itself, in an evaluation, and/or in a control electronics unit.

In some embodiments, the deformation sensor is formed by at least one strain gauge. A strain gauge can determine both an extension as well as a compression of the surface portion that is operatively coupled to the strain gauge. In addition to this, there are strain gauges for the measurement of deformations of different sizes, such that a strain gauge can be selected which is suitable for the respective container carrier, and for its cross-section, material, and other characteristics that influence the deformation. In addition, strain gauges both have a low profile, thereby avoiding consumption of much extra space, and are economical to produce and procure.

Embodiments include those in which one or more deformation sensors are arranged on an upper side and/or lower side of the container carrier. A deformation of the container carrier by the weight of the container causes an extension of the upper side of the container carrier, which is measured by a deformation sensor arranged on the upper side of the container carrier. Likewise, a deformation of the container carrier by the weight of the container causes a compression of the underside of the container carrier, which is measured by a deformation sensor arranged on the underside of the container carrier. With an arrangement of several deformation sensors on the upper side and the lower side of the container carrier, both the expansion as well as the compression are measured. This increases the measurement precision.

In some embodiments, two or more deformation sensors detect kinetic influences, such as acceleration forces and/or centrifugal forces, and establish differences from reference data with regard to the mass actually present and therefore with regard to the filling quantity. For this purpose it useful for one or more deformation sensors to be arranged on corresponding essentially horizontal surfaces of the container carrier or components thereof, and in particular, on the grippers or gripper arms. Among these are embodiments in which one or more deformation sensors are arranged on inclined surfaces or surfaces essentially aligned vertically. The different data relating to the deformation can then evaluated in common together with the respective speed values and/or acceleration values.

In some embodiments, it is useful to calibrate the weighing unit in a manner that depends on the container being filled, and in particular, on its point of balance relative to the holding and gripping element so as to zero out the weight of the empty container. This promotes the ability to reliably detect the influence of kinematic parameters on the deflection.

Embodiments also include those in which the weighing unit comprises at least four deformation sensors. The deformation sensors are arranged at different surface portions of the container carrier. Inasmuch as the container carrier has a plane of symmetry which runs through the axis of the container that is being held, it is advantageous for the deformation sensors to be arranged symmetrically relative to this plane of symmetry. With this configuration, it becomes possible to avoid inaccurate measurements that result from slightly asymmetric loadings of the container carrier by averaging the measurement results of both sides.

Some embodiments feature deformation sensors on the upper side and on the lower side of the container carrier, such that, as described heretofore, the one deformation sensor registers an expansion and the other registers a compression. Temperature-induced falsifications of the measurement results from the deformation sensors, such as, for example, a temperature-induced change in the resistance of a strain gauge, do not come into account, or only very slightly, due to the comparison of the measurement results from the upper side to the lower side. A temperature sensor and a calculation of the temperature dependency of the measurement results are therefore unnecessary.

It is further of advantage if the deformation sensors are connected in a bridge circuit. By means of a bridge circuit, an evaluation of the symmetry is possible with regard to the plane of symmetry and the differences which pertain between the upper side and the lower side, and without the need for additional electronics. A bridge circuit therefore provides an economical but also robust processing of the resistance values of the individual deformation sensors.

Advantageously, cables are soldered at contact points of the deformation sensors. In this way the measurement results from the deformation sensors can be evaluated at a location remote from the container carrier, where, for example, more space is available for an evaluation electronics unit.

It is advantageous if a plug is arranged at the end of the cable facing away from the deformation sensors. With the aid of this plug, the cable can be connected to an evaluation and/or control electronics unit of the container handling system. Should it happen that a container carrier must be exchanged or replaced, the electrical connection to the evaluation and/or control electronics unit can be easily disconnected and then re-established by means of the plug. It is particularly advantageous if the plug is configured as water-tight, such that a possible impingement of spray or condensation water on the connection will do no harm.

It is likewise advantageous for the deformation sensors to be sealed so as to protect them from water that results from spray or condensation. This promotes more accurate measurement.

It is advantageous if the transport of the containers runs at least in sections on a circular track, and the deformation sensor is arranged radially in the middle and/or radially on the inside at the container carrier. With such a transport on a circular track, the containers are held radially on the outside at the container carrier. By an arrangement of the deformation sensor radially in the middle at the container carrier, peripheral effects at the deformation of the container carrier which could occur in the region of the positioning of the container carrier are suppressed as far as can possibly be achieved. Conversely, an arrangement of the deformation sensor radially on the inside at the container carrier has the advantage that the distance interval from the deformation sensor to the container, and therefore from possible spray water, is maximized.

It is of advantage if the container carrier consists of special steel and/or plastic. Both special steel as well as a large number of plastics have reproducible moduli of elasticity, which is essential for the determination of the weight of the container from the deformation of the container carrier. Moreover, special steel and plastics can be easily processed and are well-suited as materials for container carriers.

Further proposed is a container carrier for the transporting of containers for a container handling system in accordance with the foregoing description. Containers are again understood to be bottles, cans, or the like, wherein the precise type of the containers is not of importance for the present invention. The material of the containers is also not of importance for the present invention, and they may therefore be containers made, for example, of glass, PET, or aluminum.

According to the invention, the container carrier comprises a weighing unit for detecting the weight of a container held at the container carrier, wherein the weighing unit comprises at least one deformation sensor, which is arranged on at least one surface portion of the container carrier in order to detect its deformation. With the aid of this weighing unit it is possible, during the filling of the container, for the weight of the container to be determined, and therefore the quantity of filler product being dispensed by a filling element. The deformation of the container carrier occurs due to the fact that the weight of the container increases as it is filled, and the container carrier is therefore increasingly bent out of shape, the greater the weight of the container the greater the deformation of the container carrier. The deformation of the container carrier is therefore a measure for the weight of the container. Due to the fact that the deformation sensor is arranged directly on the surface portion of the container carrier, the additional space requirement in relation to a container carrier without a deformation sensor is minimal. Due to the small additional space requirement, it is in principle even possible for a container carrier without a weighing unit to be replaced by a container carrier with a weighing unit, wherein the container handling system is extended by the function of the determination of the weight of the container.

Advantageous embodiments of the container carrier are derived from the advantageous embodiments of the container handling system with container carriers described heretofore.

In another aspect, the invention features a method for the filling of containers, such as bottles, cans, or the like. The containers are transported along a transport device with container carriers and are filled by filling elements of a filling machine with a filler product. The filling of the containers usually takes place during the transport of the containers. During the filling, the weight of the container held at the container carrier is detected by means of a weighing unit, and the filling of the container is stopped when a predetermined weight has been reached. Containers are therefore obtained which are filled with a predetermined filling quantity.

With the method, the throughflow quantity and/or duration of the respective filling element is advantageously controlled as a dependency of the measurement data from the weighing unit. Accordingly, for example, it is possible for the throughflow quantity per time unit to be reduced before the stopping of the filling of a container, such that, at the stopping of the filling, a still more precise filling quantity in the container is achieved. The reducing of the filling speed during the filling of the container can be arranged, for example, at a predetermined filling quantity and therefore a predetermined weight of the container, wherein the weight of the container is in turn again detected by means of the weighing unit.

It has transpired to be particularly advantageous if the kinetic influences, such as centrifugal forces, acceleration, and speed are evaluated in parallel with the evaluation of the measurement data from the deformation sensors, and their influence is factored out. Likewise, the container geometry, and particularly the point of balance and change of point of balance during the filling of a container, are taken into account.

According to the invention, the method is carried out by means of a container handling system in accordance with the foregoing description. In particular, therefore, the weighing unit comprises at least one deformation sensor, which is arranged on at least one surface portion of the container carrier. In particular also during the filling of the container, the deformation sensor detects the deformation of the container carrier, which is a measure for the weight of the container held at the container carrier.

Advantageously, from the measured values of the weighing unit, by means of a formula and/or a look-up table, the weight of the container is determined. This can be carried out without problems and in real time with processors currently available. On attaining a predetermined weight of the container, the filling speed is reduced during the filling of the container, and/or the filling of the container is stopped. The formula used is preferably determined empirically, wherein the parameters used in the formula are determined either by measurements or by calculations, for example with the finite element method. Likewise, the values in the look-up table are determined either by measurements or by calculations, for example with the finite element method. As an alternative to this, the filling of the container can be stopped on the reaching of a predetermined measured value of the weighing unit. This measured value, which corresponds to a predetermined weight of the container or, respectively, a predetermined filling quantity of the container, is likewise determined either by measurements or by calculations, for example with the finite element method. It is also possible, on reaching a further predetermined measured value of the weighing unit, for the filling speed to be reduced during the filling of the container.

Further embodiments, advantages, and possible applications of the invention also derive from the following description of exemplary embodiments and from the Figures. In this respect, all the features described and/or represented as illustrations are in principle the object of the invention, alone or in any desired combination, regardless of their relationships in the claims or reference to them. The contents of the claims are also deemed to be a constituent part of the description.

### BRIEF DESCRIPTION OF THE DRAWINGS

The invention is described in greater detail hereinafter on the basis of the Figures in respect of exemplary embodiments. These show, by way of example:

FIG. 1 shows a container-handling system;

FIG. 2a shows a side view of a container carrier from the system of FIG. 1 as it carries an unfilled container;

FIG. 2b shows the container carrier of FIG. 2a as it carries a partially-filled container;

FIG. 3 shows a bridge circuit; and

FIG. 4 shows a perspective view of an alternative embodiment of a container carrier from the system of FIG. 1.

Identical reference numbers are used in the figures for elements which are the same or have the same effect. Furthermore, for the purpose of easier overview, only reference numbers are represented in the individual figures which are required for the description of the respective figure.

### DETAILED DESCRIPTION

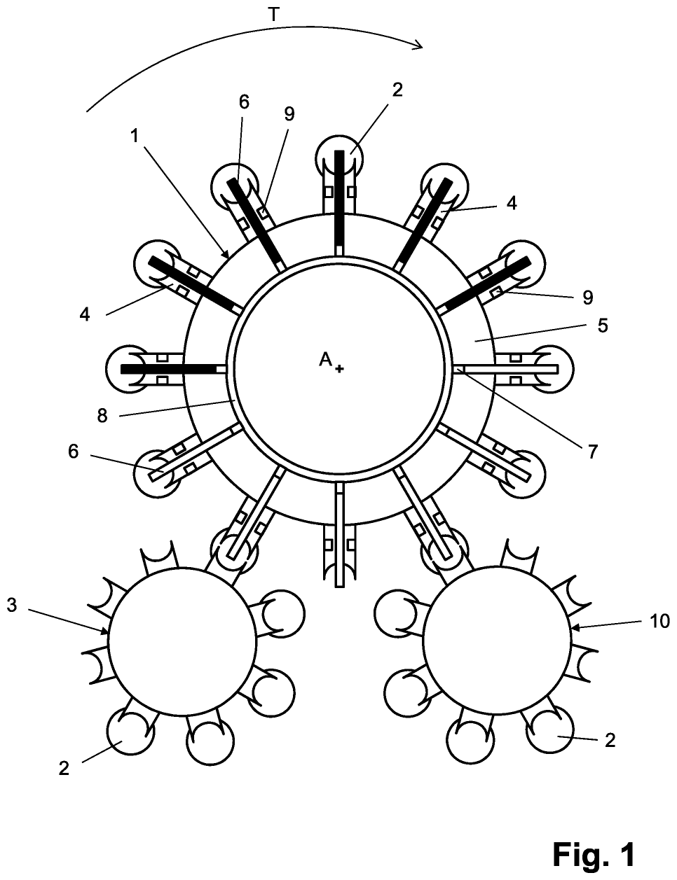

FIG. 1 shows a container-handling system 1 that includes a filling machine. The container-handling system 1 includes a rotor 5 that rotates about a vertical axis “A”. Along the circumference of the rotor 5 are container carriers 4. A container carrier 4 receives a container 2 at an inlet star 3 and transport containers 2 in a transport direction “T” along a circular arc as the rotor 5 rotates. The container carrier 4 then discharges the container 2 at an outlet star 10, which takes the container for further processing. The container-handling system 1 also includes filling elements 6. Each filling element 6 connects to a circular channel 8 by way of a valve 7.

In operation, when the container carrier 4 positions the container 2 at a filling element 6, the valve 7 opens, thus allowing filling material that is stored in the channel 8 to fill the container 2. The filling elements 6 shown in black are those in which the valve 7 is open so that the container 2 is being filled. The remaining filling elements 6 are those in which the valve 7 is closed.

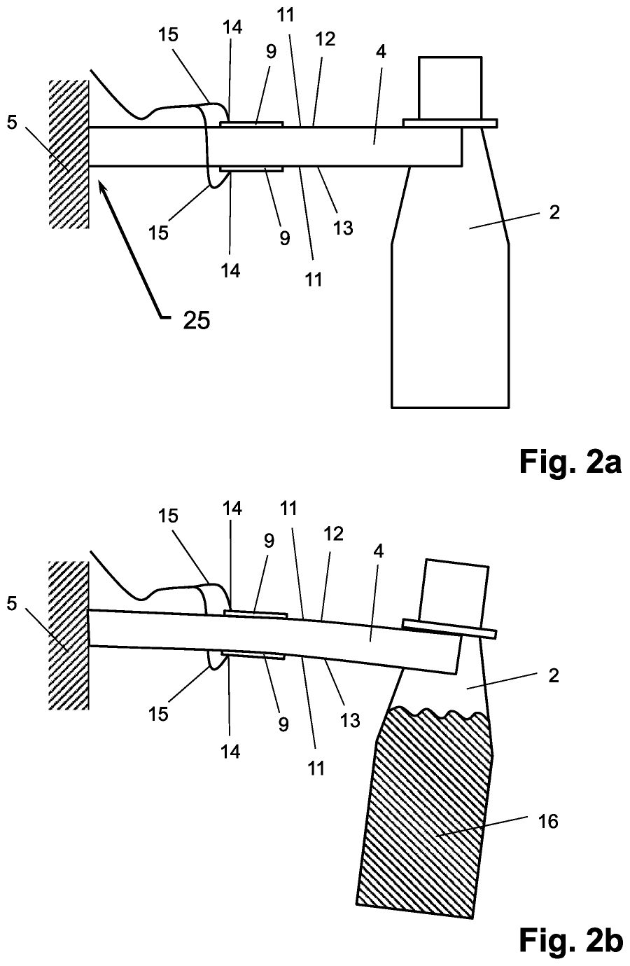

Referring to FIG. 2a, a carrier 4 is a cantilevered structure that extends radially outward from the rotor 5 from a proximal end that mounts to the rotor 5 to a distal end, from which a gripper suspends the container 2. The container 2 is empty in FIG. 2a but partially filled in FIG. 2b.

In FIG. 2a, the container 2 is empty. Hence, any deformation of carrier 4 arises only from the container's empty weight. As the container 2 fills, the container's growing weight deforms the carrier 4, as shown in FIG. 2b. This results in the carrier's deformation, which is shown in exaggerated form in FIG. 2b for clarity of exposition.

Deformation sensors 9 on the carrier's surface 11 measure the carrier's deformation. Since the extent of deformation depends on the weight of the filling material in the container 2, it is possible to infer the amount of product in the container 2 by observing the extent of deformation. In some embodiments, the deformation sensors 9 are strain gauges on upper and lower sides 12, 13 of the carrier 4. However, other types of deformations sensors 9 can be used.

In some cases, the container 2 is improperly taken up in a slightly asymmetric manner so that it is slightly offset at the container carrier 4. To avoid measurement inaccuracies, it is useful for the deformation sensors 9 to be arranged on either side of a plane of symmetry at the carrier 4. Measurements from different sides of the plane of symmetry can then be used to estimate the container's weight.

The filling valve's state is controlled based on the sensed weight. In some embodiments, the valve 7 is closed upon reaching a predetermined weight. In other embodiments, the rate of filling is slowed upon reaching a first predetermined weight and stopped upon reaching a second predetermined weight. This permits the weight of filling material to be controlled more accurately.

The valve 7 is made to stop filling the container when the deformation sensor's output reaches a predetermined measured value. The predetermined measured value is obtained either empirically, by measurement, or by calculation. A suitable calculation method is one that relies on the finite-element method to establish a correspondence between the container's weight and the extent of deformation. Some embodiments rely on a look-up table or formula to determine weight based on deflection. In some embodiments, finite-element calculations to infer weight from deflection are carried out in real time using a fast processor.

Each deformation sensor 9 has a contact point 14 to which a cable 15 connects. This permits a signal from the deformation sensor 9 to be evaluated remotely from the carrier 4.

The illustrated embodiment shows upper and lower deformation sensors 9 on the upper side 12 and lower side 13 of the carrier 4, respectively. The upper and lower deformation sensors 9 experience extension and compression, respectively.

In principle, only one deformation sensor 9 is required. However, having two deformation sensors 9 permits cancellation of errors due to sources that affect both sensors 9 equally. For example, if only one deformation sensor 9 were present, a temperature-induced change in sensor performance could not be accounted for. In contrast, by taking a difference between two deformation sensors 9, any such temperature-induced errors could be cancelled.

A preferred embodiment features four deformation sensors 9, with two on the upper side 12 and two on the lower side 13. The deformation sensors 9 are arranged in pairs on either side of a plane of symmetry of the carrier 4. This configuration permits cancellation of error due to both temperature changes and error that arises when the container 2 is not held symmetrically at the carrier 4.

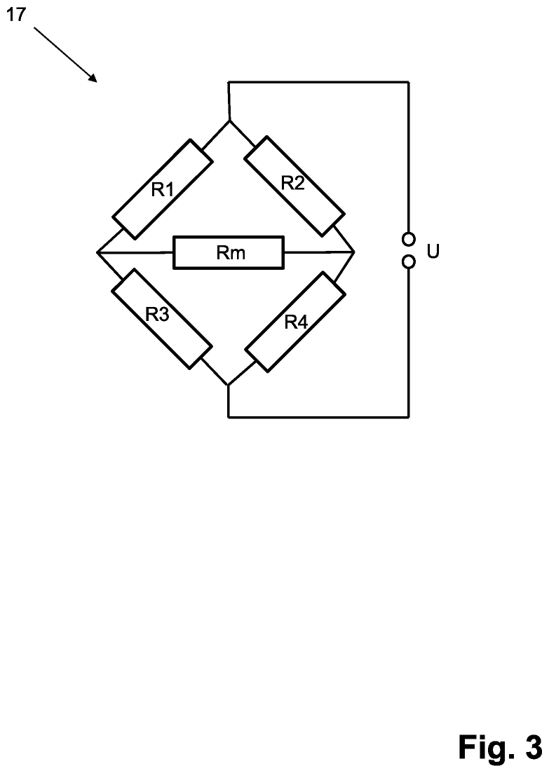

In those embodiments in which the deformation sensors 9 are strain gauges, electrical resistance of each deformation sensor 9 changes as a result of compression or extension thereof. In such cases, it is useful to arrange the sensors 9 to form a bridge circuit as shown in FIG. 3. In the illustrated bridge circuit, R1 and R4 represent electrical resistances of deformation sensors 9 on the upper surface 12 on opposite sides of the plane of symmetry. The remaining two resistances, R3 and R4, represent electrical resistances of deformation sensors 9 on the lower side 13 on opposite sides of the plane of symmetry. A voltage U applied as shown results in a voltage drop across a measurement resistor Rm. This voltage drop indicates an extent of the carrier's deformation.

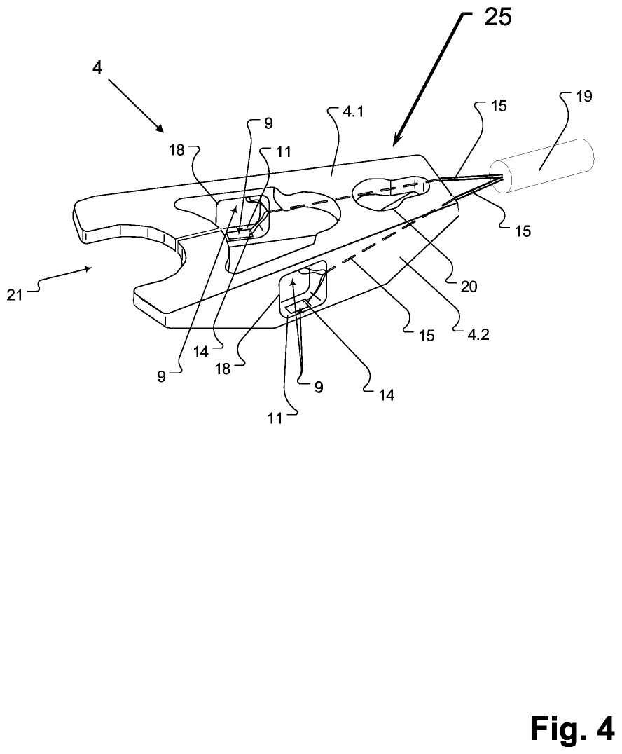

In an alternative embodiment, shown in FIG. 4, a container carrier 4 takes the form of a passive clip that elastically deforms. The container carrier 4 includes a distal holding end 21 that is elastically deformed to receive a container 2. The restoring force that results from this deformation tends to fix the container 2 in a gripping position.

The clip features two cavities 18 having horizontal surfaces 11. In the illustrated embodiment, each cavity 18 is a window or cut-out opening of a lateral element 4.1, 4.2 of the container carrier 4. Each cavity 18 accommodates two deformation sensors 18 on the two horizontal surfaces 11 thereof. As a result, there are four deformation sensors 9. However, other embodiments include additional deformation sensors 9.

At its proximal end, the container carrier 4 has an alignment opening 20 that promotes correctly positioning the container carrier 4 on a container-handling system 1. When the container carrier 4 is in its correct position, the distal gripping end 21 is suitably located to take up a container 2.

Cables 15 extend from contact points 14 of the deformation sensors 9 proximally towards a plug 19 that receives the cables 15. These provide electrical communication with the deformation sensors 9. The use of a plug 19 makes it possible to rapidly connect the deformation sensors 9 to a corresponding socket on the container-handling system 1. This makes it possible to swiftly replace the container carrier 4 as a modular unit should it become worn or broken.

Preferably, the plug 19 is water-tight to avoid having water due to condensation or spray influence the measurements. In some embodiments, the deformation sensors 9 are covered with a protective material or the cavities 18 are filled with a casting material to protect the deformation sensors 9 from being in contact with stray water.

The invention has been described heretofore on the basis of exemplary embodiments, and in this context the container carriers have been represented only schematically. It is understood that more complex grippers, in particular also actively controllable grippers with gripper arms mounted on bearings and capable of pivoting, can be provided for in an analogous manner.

It is further understood that a large number of modifications or derivations are possible without thereby departing from the scope of protection of the invention as defined by the claims.

1-18. (canceled)

19. An apparatus comprising a container carrier and a deformation-sensor system, wherein said container carrier connects to a filling machine at which said container carrier is held, a gripper that suspends a container during transport thereof along a transport direction, and a surface, and wherein said deformation-sensor system comprises a deformation sensor that is arranged on said surface to detect deformation of said container carrier caused by an increase in weight of said container as filling product enters said container during filling thereof.

20. The apparatus of claim 18, wherein said deformation sensor comprises a strain gauge.

21. The apparatus of claim 18, wherein said deformation-sensor system comprises a plurality of deformation sensors at said container carrier.

22. The apparatus of claim 18, wherein said deformation-sensor system comprises a first deformation sensor and a second deformation sensor, wherein said first deformation sensor is on an upper side of said container carrier, and wherein said second deformation sensor is on an underside of said container carrier.

23. The apparatus of claim 18, wherein said deformation-sensor system comprises at least four deformation sensors, all of which are on corresponding surfaces of said container carrier.

24. The apparatus of claim 18, wherein said deformation-sensor system comprises plural deformation sensors, each of which defines a resistance in a bridge circuit.

25. The apparatus of claim 18, wherein said deformation-sensor system comprises plural deformation sensors, each of which comprises a contact point, said apparatus further comprising cables that are soldered to said contact points.

26. The apparatus of claim 18, wherein said deformation-sensor system comprises plural deformation sensors that are connected in a bridge circuit, wherein said apparatus further comprises a plug and cables that extend between said deformation sensors and said plug, that is arranged at an end of said cable that faces away from said deformation sensors.

27. The apparatus of claim 18, wherein said deformation sensor is sealed to prevent contact between said deformation sensor and water.

28. The apparatus of claim 18, wherein said container carrier transports said container along a circular track that defines a circle and wherein said deformation sensor is disposed within said circle.

29. The apparatus of claim 18, wherein said container carrier is a unitary plastic structure made of a plastic that has a reproducible module of elasticity.

30. The apparatus of claim 18, wherein said container carrier is a multi-part structure that is made of a steel that has a reproducible module of elasticity.

31. The apparatus of claim 18, wherein said deformation sensor is disposed on a surface of said container carrier between proximal and distal ends thereof.

32. The apparatus of claim 18, further comprising a container-handling machine that comprises a rotor that comprises filling elements, wherein said container carrier is one of a plurality of container carriers on said rotor.

33. A method comprising suspending a container from a gripper of a container carrier, transporting said container along a transport direction, while transporting said container, filling said container, using a deformation-sensor system, measuring deformation of said container carrier as a result of an increase in said container's weight as filing product enters said container during filling thereof, determining that a predetermined weight has been reached, and halting filling of said container, wherein said deformation-sensor system comprises a deformation sensor that is arranged on a surface of said container carrier.

34. The method of claim 32, further comprising converting said deformation into a weight, wherein converting said deformation into a weight comprises using a look-up table to determine a weight that corresponds to a particular deformation.

35. The method of claim 32, further comprising converting said deformation into a weight, wherein converting said deformation into a weight comprises using a formula to determine a weight that corresponds to a particular deformation.

36. The method of claim 32, wherein said deformation-sensor system comprises plural deformation sensors, each of which is arranged on a corresponding surface of said container carrier and wherein measuring said deformation comprises evaluating said deformation based on measurements from all of said deformation sensors.

37. The method of claim 32, further comprising measuring a kinematic property of said container and using said kinematic property and measurements from said deformation-sensor system to determine when to halt filling of said container.
